(19) United States
(12) Patent Application Publication
(10) Pub. No.: US 2019/0176317 A1
(43) Pub. Date: Jun. 13, 2019

(54) HAND TOOL ASSEMBLY

(71) Applicant: Chung-Yu Tsai, Taichung (TW)

(72) Inventor: Chung-Yu Tsai, Taichung (TW)

(21) Appl. No.: 15/836,907

(22) Filed: Dec. 10, 2017

(51) Int. Cl. B25G 1/06; B25B 23/00

(52) U.S. Cl. CPC B25G 1/066; B25B 15/04; B25B 23/0042

(57) ABSTRACT

A hand tool assembly includes a grip having a slot communicating with the first end and a lateral side of the grip. A rod is pivotably connected to the grip and includes a function end. The rod is engaged with the slot to be co-axially connected with the grip, or the rod is positioned perpendicularly relative to the grip. An end part is connected to the second end of the grip and includes an engaging portion which protrudes beyond the second end of the grip. A magnet is connected to one end of the rod so as to attract the end part in the grip.

### BACKGROUND OF THE INVENTION

### 1. Fields of the Invention

The present invention relates to a hand tool assembly, and more particularly, to a hand tool assembly with a rod which can be positioned axially or laterally relative to the grip.

### 2. Descriptions of Related Art

The conventional hand tool assembly as disclosed in U.S. Pat. No. 8,915,169, and comprises a handle having a limiting portion and a slot. The limiting portion is disposed in the handle and includes an inner space, a first sleeve portion and a second sleeve portion. The first and second sleeve portions respectively have openings communicating with the inner space. The slot communicates with the inner space and opens to the outside of the handle. The handle is provided with a pin which is disposed through the inner space. The first sleeve portion and the second sleeve portion are disposed around the axis of the pin. Either of the first and second sleeve portions has two corresponding abutting members which are substantially parallel to the axis of the pin, or the first and second sleeve portions are entirely encompassed within the handle and located on the longitudinal central axis of the handle. The longitudinal central axis is substantially perpendicular to the axis of the pin. A driving rod has a working end and a fixation end corresponding to the working end. The fixation end is formed with an elongate through hole extending along the longitudinal direction of the driving rod. The pin is movably disposed in the elongate through hole. The fixation end is disposed into the inner space through the slot. The driving rod is slidable and swingable relative to the pin. The fixation end is controllably selectively inserted into the first sleeve portion or the second sleeve portion and the fixation end abut against the two abutting members of one of the first and second sleeve portions so that the driving rod is held.

However, there are only two forms of application of the handle tool. Besides, the limitation member is selectively restricts the fixation end of the driving rod to allow the driving rod to be adjusted relative to the handle. The limitation member includes a complicated structure so that when manufacturing the tool assembly, the limitation member is located in the molding set of the handle, and the handle needs to have a receiving space for accommodating the limitation member. Therefore, the manufacturing cost is high when compared with that of other hand tool assemblies.

The present invention intends to provide a hand tool assembly to eliminate the shortcomings mentioned above.

### SUMMARY OF THE INVENTION

The present invention relates to a hand tool assembly and comprises a grip having a slot communicating with the first end and a lateral side of the grip. A rod is pivotably connected to the grip and includes a function end. The rod is engaged with the slot to be co-axially connected with the grip, or the rod is positioned perpendicularly relative to the grip. An end part is connected to the second end of the grip and includes an engaging portion which protrudes beyond the second end of the grip. A magnet is connected to one end of the rod so as to attract the end part in the grip.

The end part is made by metal, and when the first end of the rod is engaged with the axial recess, the first end of the rod contacts the first end of the end part. The function end of the rod can be connected with an object such as a screwdriver bit, and a hammer can be used to hit the end part so as to provide an impact force to the screwdriver bit. The rod can be positioned axially with the grip or be perpendicular to the grip. There will be three different operation modes including the impact mode. The second end of the end part can be connected with a rectangular tool that by rotating the rectangular tool, the hand tool assembly is rotated to output torque, and this is the fourth operational mode.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view of the hand tool assembly of the present invention;

FIG. 2 is a side view of the hand tool assembly of the present invention;

FIG. 3 is a cross sectional view, taken along line 3-3 in FIG. 2;

FIG. 4 is a perspective view to show that the rod is positioned perpendicular relative to the grip of the hand tool assembly of the present invention;

FIG. 5 is an end view to illustrate the hand tool assembly of the present invention in FIG. 4;

FIG. 6 is a cross sectional view, taken along line 6-6 in FIG. 5;

FIG. 7 shows that when the rod is pulled to disengage from the lateral recess, the rod is able to be pivoted about the pivot;

FIG. 8 is a cross sectional view to show that the rod is pivoted from the position in FIG. 7 to an axial position relative to the grip;

FIG. 9 shows that the rod is engaged with the axial recess;

FIG. 10 shows that the rod is positioned perpendicularly relative to the grip;

FIG. 11 is an end view to illustrate the hand tool assembly of the present invention in FIG. 10;

FIG. 12 is a cross sectional view, taken along line 12-12 in FIG. 11, and

FIG. 13 shows yet another embodiment of the present invention.

### DETAILED DESCRIPTION OF THE PREFERRED EMBODIMENT

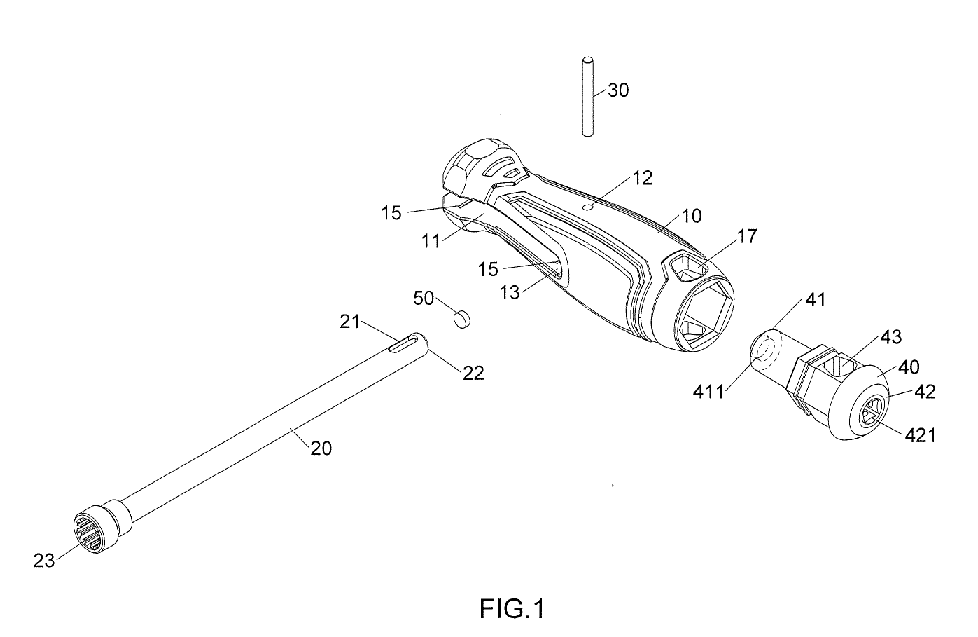

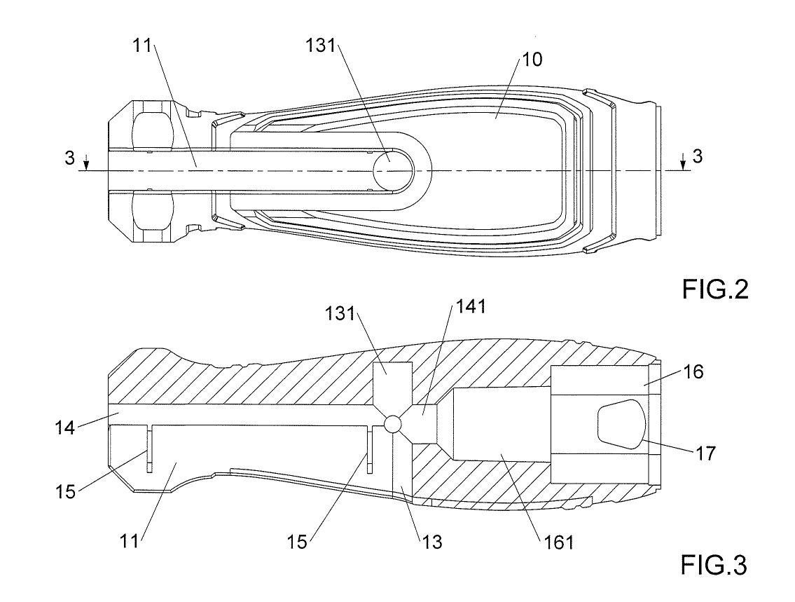

Referring to FIGS. 1 to 3, the hand tool assembly of the present invention comprises a grip 10 having a slot 11 defined through the wall thereof, and the slot 11 communicates with the first end of the grip 10 and the lateral side of the grip 10. The length of the slot 1 is about half of the total length of the grip 10. A pivotal hole 12 is defined laterally in the grip 10 and communicates with the slot 11. A lateral hole 13 is defined radially in the grip 10 and communicates with the slot 11, and an axial hole 14 is defined axially in the first end of the grip 10 and communicates with the slot 11. The lateral hole 13 defines a lateral recess 131 at one end thereof. The lateral recess 131 is located in the grip 10. The axial hole 14 defines an axial recess 141 at one end thereof, and the axial recess 141 is located in the grip 10. The axis of the lateral recess 131 is perpendicular to the axis of the axial recess 141. The inner diameter of the lateral recess 131 is equal to the inner diameter of the axial recess 141. Multiple ribs 15 protrude from one of two inside surfaces of the slot 11. An axial passage 16 is defined in the second end of the grip 10 and communicates with an axial path 161 located in the grip 10. The axial path 161 is smaller than the axial passage 16 and communicates between the axial recess 141 and the axial passage 16. The axial passage 16 is a hexagonal passage. A lateral passage 17 is defined through the second end of the grip 10.

A rod 20 includes an elongate hole 21 defined in the first end 22 thereof, and a function end 23 is formed on the second end of the rod 20. The rod 20 is a solid rod or a hollow rod. Preferably, the rod is a metallic rod. The function end 23 is a polygonal recess. A pivot 30 extends through the elongate hole 21 and the pivotal hole 12 when the first end 22 of the rod 20 is inserted into the lateral hole 13. Therefore, the rod 20 is pivotable about the pivot 30. When the rod 20 is inserted into the lateral hole 13 and pivoted to engage the first end 22 of the rod 20 with the axial recess 141, the rod 20 is co-axially connected with the grip 10. When the rod 20 is inserted in the lateral hole 13 and pivoted to engage the first end 22 of the rod 20 with the lateral recess 131, the rod 20 is perpendicularly connected with the grip 10.

An end part 40 includes a first end 41 and a second end 42, wherein the first end 41 of the end part 40 is inserted into the axial passage 16 in the second end of the grip 10. The distal end of the first end 41 of the end part 40 is located in the axial recess 141. When the first end 22 of the rod 20 is engaged with the axial recess 141, the first end 22 of the rod 20 contacts the first end 41 of the end part 40. The second end 42 of the end part 40 protrudes beyond the second end of the grip 10. The second end 42 of the end part 40 includes an engaging portion 421 which is a rectangular recess. A transverse hole 43 is defined laterally through the end part 40 and communicates with the lateral passage 17. A magnet 50 is connected to the first end 22 of the rod 20 and magnetically attracts the first end 41 of the end part 40. The end part 40 is made of metal or hard material.

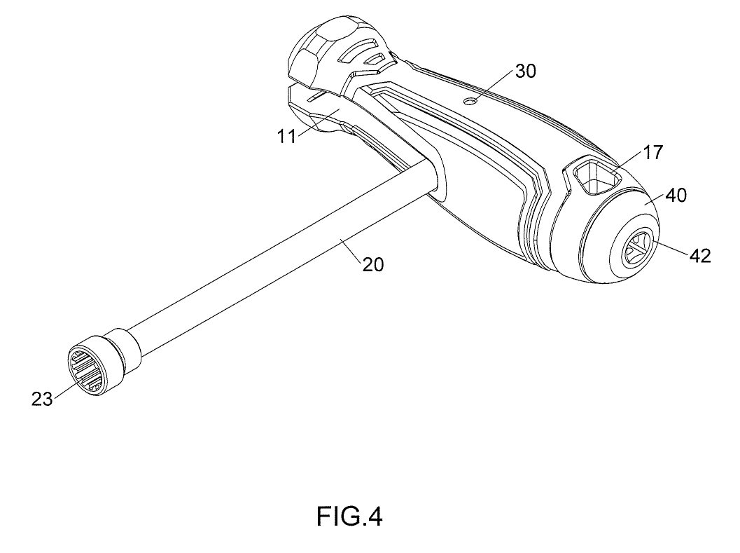

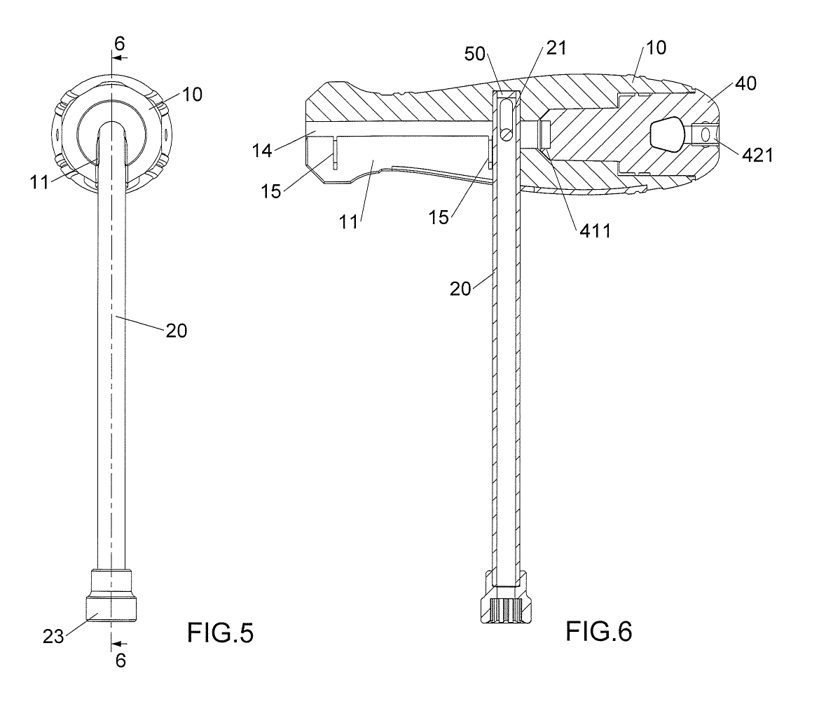

As shown in FIGS. 4 to 6, the rod 20 is inserted into the lateral hole 13 and the first end 22 of the rod 20 is engaged with the lateral recess 131. Therefore, the rod 20 is perpendicular to the grip 10 and a T-bar tool is formed.

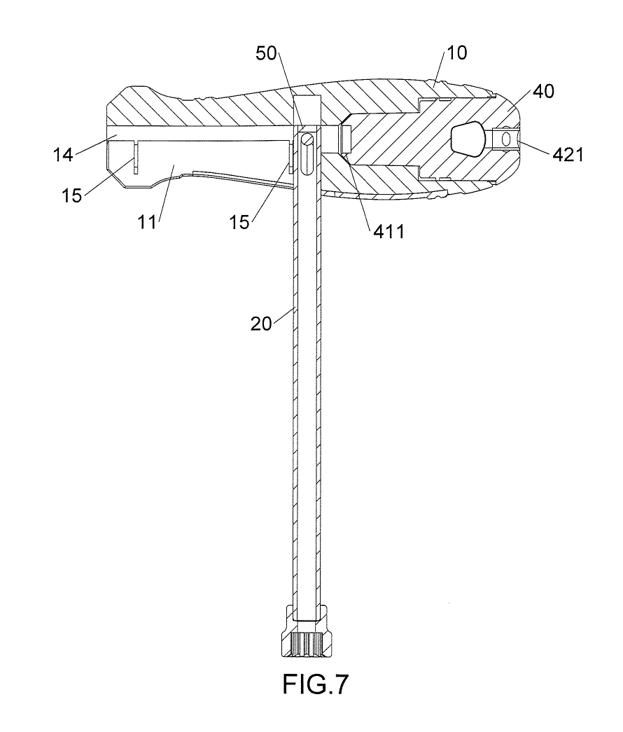

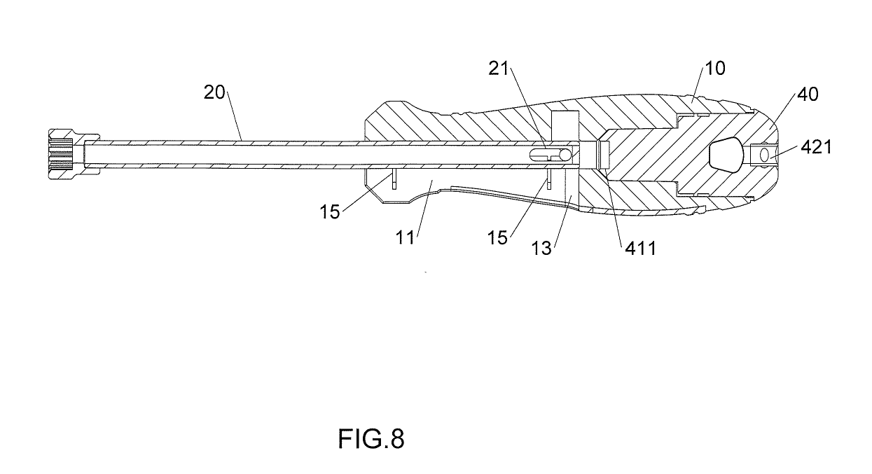

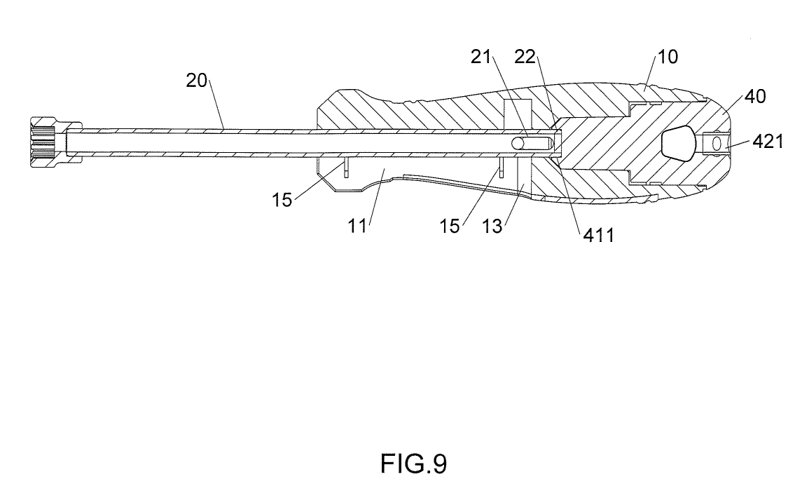

FIG. 7 shows that the rod 20 is pulled to disengage from the lateral recess 131, so that the rod 20 is pivotable about the pivot 30. As shown in FIGS. 8 and 9, the first end 22 of the rod 20 is then engaged with the axial recess 141. Therefore, the rod 20 is co-axially connected to the grip 10.

As shown in FIG. 6, when pivoting the rod 20, the ribs 15 provide proper resistance, and one of the ribs 15 restricts the rod 20 as shown in FIG. 8.

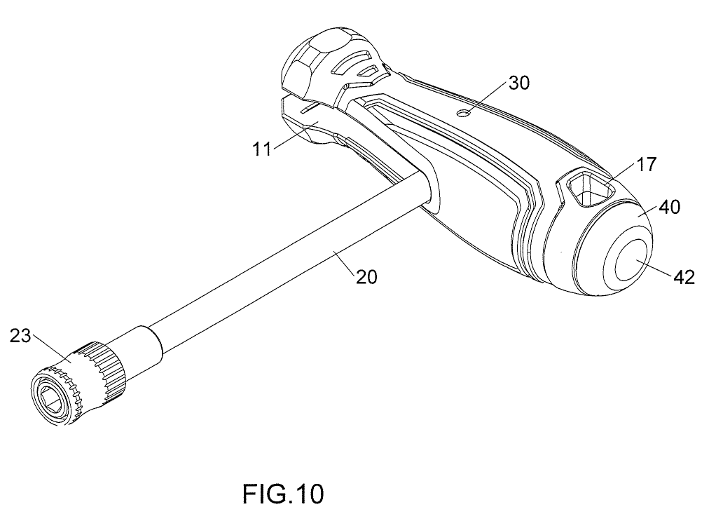

As shown in FIGS. 10 and 12, the rectangular recess of the function end 23 can be connected with different types of screwdriver bits. The end part 40, in this embodiment, does not include the reception recess 411. The end part 40 is made the material that is identical to that of the grip 10.

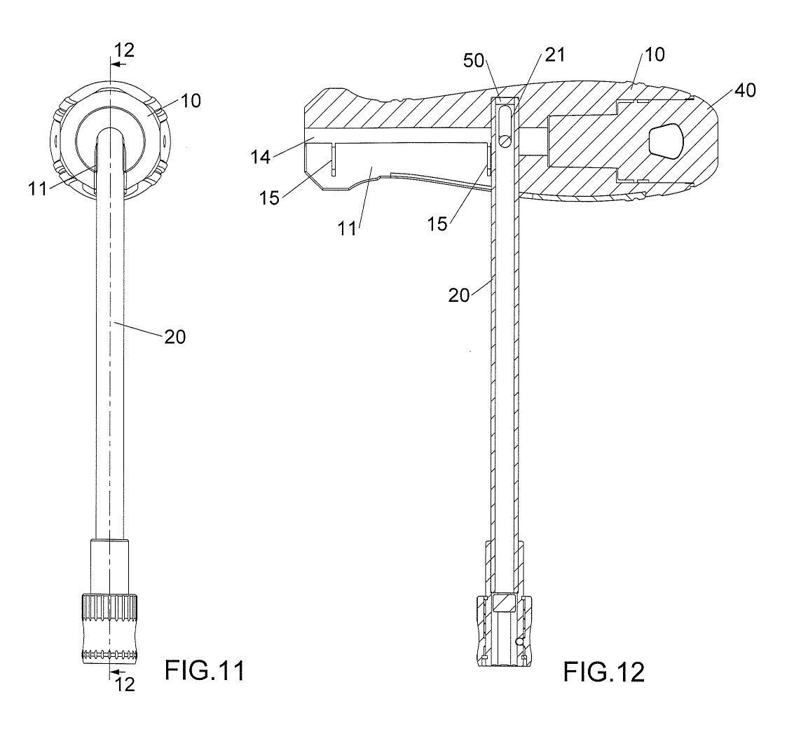

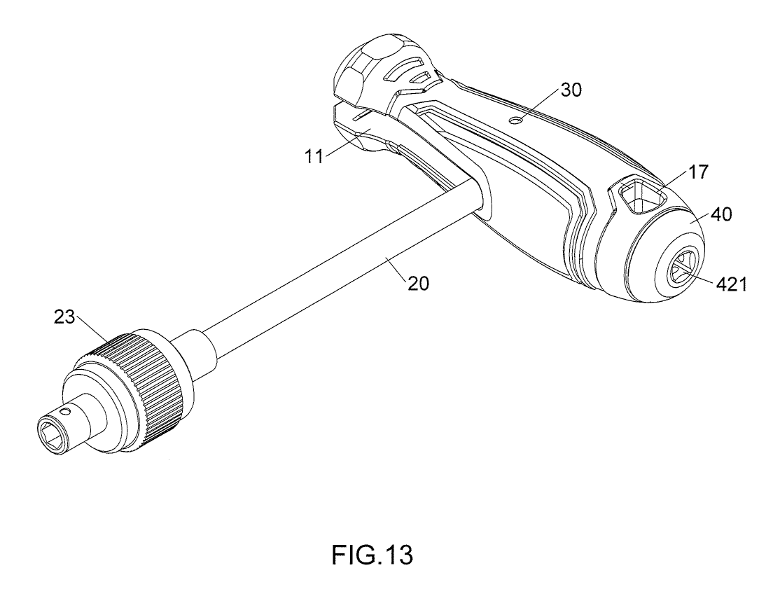

FIG. 11 shows that the function end 23 is connected with a ratchet unit for changing operational direction of a screwdriver bit.

Another embodiment shows that the rod 20 does not connected with the magnet 50. The function end 23 is formed with a screwdriver bit. The engaging portion 421 is a hexagonal protrusion so as to be cooperated with an open end wrench.

The advantages of the present invention are that the end part 40 is made of metal, and when the first end 22 of the rod 20 is engaged with the axial recess 141, the first end 22 of the rod 20 contacts the first end 41 of the end part 40. When the function end 23 of the rod 20 is connected with an object such as a screwdriver bit, a hammer is used to hit the end part 40 so as to provide an impact force to the screwdriver bit.

The rod 20 can be positioned axially with the grip 10 or be perpendicular to the grip 10. There will be three different operation modes including the impact operational mode.

The second end 42 of the end part 40 can be connected with a rectangular tool such that when rotating the rectangular tool, the hand tool assembly is rotated to output torque, and this is the fourth operational mode.

When the end part 40 is made of hard material, the hand tool assembly includes the T-bar operational mode, the axial operational mode, the impact operational mode. Of course, the end part 40 may also be made of soft material when needed.

As shown in FIG. 9, the first end 22 of the rod 20 extends through the axial recess 141 and is engaged with the reception recess 411, such that the grip 10 and the rod 20 are connected to each other, and the rod 20 is also connected with the end part 40. The rod 20, the grip 10 and the end part 40 are formed as a one-piece tool assembly.

The magnet 50 is connected to the first end 22 of the rod 20 and is used to magnetically attract the first end 41 of the end part 40.

While we have shown and described the embodiment in accordance with the present invention, it should be clear to those skilled in the art that further embodiments may be made without departing from the scope of the present invention.

1. A hand tool assembly comprising:
a grip having a slot defined through a wall thereof, the slot communicating with a first end of the grip and a lateral side of the grip, a pivotal hole defined laterally in the grip and communicating with the slot, a lateral hole defined radially in the grip and communicating with the slot, an axial hole defined axially in the first end of the grip and communicating with the slot, the lateral hole defining a lateral recess at an end thereof, the lateral recess located in the grip, the axial hole defining an axial recess at an end thereof, the axial recess located in the grip, an axis of the lateral recess being perpendicular to an axis of the axial recess, an inner diameter of the lateral recess being equal to an inner diameter of the axial recess, multiple ribs extending from one of two inside surfaces of the slot, an axial passage defined in a second end of the grip and communicating with an axial path located in the grip, the axial path communicating between the axial recess and the axial passage, a lateral passage defined through the second end of the grip;
a rod having an elongate hole defined in a first end thereof, a function end formed on a second end of the rod, a pivot extending through the elongate hole and the pivotal hole when the first end of the rod is inserted into the lateral hole, the rod pivotable about the pivot; wherein when the rod is inserted into the lateral hole and pivoted to engage the first end of the rod with the axial recess, the rod is co-axially connected with the grip, all the multiple sibs provide resistance for the rod; wherein when the rod is inserted in the lateral hole and pivoted to engage the first end of the rod with the lateral recess, the rod is perpendicularly connected with the grip, one of the multiple ribs restricts the rod;
an end part including a first end and a second end, the first end of the end part inserted into the axial passage in the second end of the grip, a distal end of the first end of the end part located in the axial recess, when the first end of the rod is engaged with the axial recess, the first end of the rod contacts the first end of the end part, the second end of the end part protruding beyond the second end of the grip, the second end of the end part including an engaging portion which protrudes beyond the second end of the grip, a transverse hole defined laterally through the end part and communicating with the lateral passage, and
a magnet connected to the first end of the rod and magnetically attracts the first end of the end part when the rod is co-axially connected with the grip and the first end of the rod engages with the axial recess.

2. The hand tool assembly as claimed in claim 1, wherein the lateral recess and the axial recess each have a circular cross section.

3. The hand tool assembly as claimed in claim 1, wherein the axial path have a circular cross section.

4. The hand tool assembly as claimed in claim 1, wherein the function end includes a polygonal recess for being connected with a screwdriver bit, or the function end has a screwdriver bit connected thereto.

5. The hand tool assembly as claimed in claim 1, wherein the rod is a solid rod or a hollow rod, the rod is a metallic rod.

6. The hand tool assembly as claimed in claim 1, wherein the magnet is a tubular part.

7. The hand tool assembly as claimed in claim 1, wherein the first end of the end part includes a reception recess which communicates with the axial recess, when the first end of the rod is engaged with the axial recess, the first end of the rod is inserted into the reception recess.

8. The hand tool assembly as claimed in claim 7, wherein the reception recess is a circular recess.

9. The hand tool assembly as claimed in claim 1, wherein the transverse hole communicates with the engaging portion which is a rectangular recess.

10. The hand tool assembly as claimed in claim 1, wherein the end part is made of metal or is made of a material that is identical to that of the grip.

11. The hand tool assembly as claimed in claim 1, wherein the engaging portion is a hexagonal protrusion for cooperating with an open end wrench.
